(19) United States
(12) Patent Application Publication
(10) Pub. No.: US 2012/0007856 A1
(43) Pub. Date: Jan. 12, 2012

(54) STEREOSCOPIC DISPLAY DEVICE

(76) Inventor: Edzer Lienson Wu, Taipei (TW)

(21) Appl. No.: 13/086,232

(22) Filed: Apr. 13, 2011

(30) Foreign Application Priority Data
Jul. 7, 2010 (TW) 99122382

(51) Int. Cl. G06T 15/00

(52) U.S. Cl. 345/419

(57) ABSTRACT

A stereoscopic display device includes a display panel, two different polarized backlights and a synchronization module. The display panel is to alternately generate left-eye visible images and right-eye visible images. The two different polarized backlights are to alternately illuminate the display panel so as to output the left-eye visible images and right-eye visible images, respectively. The synchronization module is to synchronize the left-eye visible images and right-eye visible images with illumination periods of the respective polarized backlights.

### RELATED APPLICATIONS

The present application claims priority from, Taiwan Application Serial Number 99122382, filed on Jul. 7, 2010, the disclosure of which is hereby incorporated by reference herein in its entirety.

### BACKGROUND

1. Field of Invention

The present invention relates to a display device. More particularly, the present invention relates to a stereoscopic display device and its displaying method.

2. Description of Related Art

Most stereoscopic display technology is creating or enhancing the illusion of depth in an image by presenting two offset images separately to the left and right eye of the viewer. In particular, a stereoscopic display would provide two different polarized left-eye visible image and right-eye visible image. When the viewer wears an active polarizer or a passive polarizer, his or her left eye and right eye can see left-eye visible image and right-eye visible image, thereby constituting a stereoscopic image in the viewer's brain.

For a conventional stereoscopic display technology applied on a LCD display device, the viewer needs to wear an active polarizer in order to see the left-eye visible images and right-eye visible images, respectively. The viewer who wears the active polarizer would easily feel uncomfortable and tired. Besides, the active polarizer is costly than the passive polarizer is.

Most conventional stereoscopic display technologies using passive polarizer are applied on the projector, e.g. the projectors in the cinema theater. It usually requires two projectors to provide left-eye visible images and right-eye visible images with half resolutions to constitute full resolution visible images. Also the left and right eye images have to be perfectly aligned to produce accurate stereoscopic image without shivering. It is neither convenient nor easy to install such stereoscopic display system with such requirements in a common home.

However, more and more 3-D videos and games are available in the consumer electronic market, a stereoscopic display system is thus desired. For the forgoing reasons, there is a need for inventing an economic and comfortable stereoscopic display system.

### SUMMARY

It is therefore an objective of the present invention to provide an improved stereoscopic display technology.

In accordance with the foregoing and other objectives of the present invention, a stereoscopic display device is provided to include a display panel, two different polarized backlights and a synchronization module. The display panel is to alternately generate left-eye visible images and right-eye visible images. The two different polarized backlights are to alternately illuminate the display panel so as to output the left-eye visible images and right-eye visible images, respectively. The synchronization module is to synchronize the left-eye visible images and right-eye visible images with illumination periods of the respective polarized backlights.

According to an embodiment disclosed herein, the two different polarized backlights are two types of linearly-polarized backlights.

According to another embodiment disclosed herein, the two types of linearly-polarized backlights includes a vertically-polarized backlight and a horizontally-polarized backlight.

According to another embodiment disclosed herein, the two different polarized backlights are two types of circularly-polarized backlights.

According to another embodiment disclosed herein, the two types of circularly-polarized backlights include a clockwise-polarized backlight and a counter-clockwise-polarized backlight.

According to another embodiment disclosed herein, the two different polarized backlights includes two cold-cathode fluorescent lamps.

According to another embodiment disclosed herein, the two different polarized backlights includes two LED light bars.

According to another embodiment disclosed herein, the display panel is a LCD display panel.

According to another embodiment disclosed herein, the display panel is a non-active illuminative display panel.

According to another embodiment disclosed herein, the two different polarized backlights consist essentially of a single light source, a single transflective prism and two polarizing lens sets, each polarizing lens set includes a reflector, a switch shutter and a polarizing lens. The switch shutter is located between the reflector and the single light source. The polarizing lens is located between the single transflective prism and the reflector.

According to another embodiment disclosed herein, the two polarizing lens sets include two different types of linearly-polarized polarizing lenses.

According to another embodiment disclosed herein, one of the two different types of linearly-polarized polarizing lenses is a vertically-polarized polarizing lens, and the other of the two different types of linearly-polarized polarizing lenses is a horizontally-polarized polarizing lens.

According to another embodiment disclosed herein, the two polarizing lens sets comprise two different types of circularly-polarized polarizing lenses.

According to another embodiment disclosed herein, one of the two different types of circularly-polarized polarizing lenses is a clockwise-polarized polarizing lens, and the other of the two different types of circularly-polarized polarizing lenses is a counter-clockwise-polarized polarizing lens.

According to another embodiment disclosed herein, the synchronization module is electrically connected with the display panel and each switch shutter of the two polarizing lens sets.

According to another embodiment disclosed herein, the two polarizing lens sets define two different types of linearly-polarized backlight routes respectively.

According to another embodiment disclosed herein, one of the two different types of linearly-polarized backlight routes is a vertically-polarized backlight route, and the other of the two different types of linearly-polarized backlight routes is a horizontally-polarized backlight route.

According to another embodiment disclosed herein, the two polarizing lens sets define two different types of circularly-polarized backlight routes respectively.

According to another embodiment disclosed herein, one of the two different types of circularly-polarized backlight routes is a clockwise-polarized backlight route, and the other of the two different types of linearly-polarized backlight routes is a counter-clockwise-polarized backlight route.

In accordance with the foregoing and other objectives of the present invention, a stereoscopic image displaying method includes the following steps. A display panel is used to alternately generate left-eye visible images and right-eye visible images. Two different polarized backlights are used to alternately illuminate the display panel so as to output the left-eye visible images and right-eye visible images, respectively. The left-eye visible images and right-eye visible images are synchronized with illumination periods of the respective polarized backlights.

Thus, the stereoscopic display device disclosed herein utilizes two different types of polarized backlights to alternately illuminates the display panel for alternately generates left-eye visible images and right-eye visible images, thereby combining to form stereoscopic visible images.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1 & 2 illustrate an operation way of a stereoscopic display device according to a first embodiment of this invention;

FIG. 3 illustrates a detailed structure of the stereoscopic display device according to the first embodiment of this invention;

FIG. 4 illustrates an operation principle of the stereoscopic display device according to the first embodiment of this invention;

FIG. 5 illustrates a detailed structure of a stereoscopic display device according to a second embodiment of this invention;

FIGS. 6&7 illustrate an operation way of the stereoscopic display device according to the second embodiment of this invention; and

FIG. 8 illustrates an operation principle of the stereoscopic display device according to the second embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

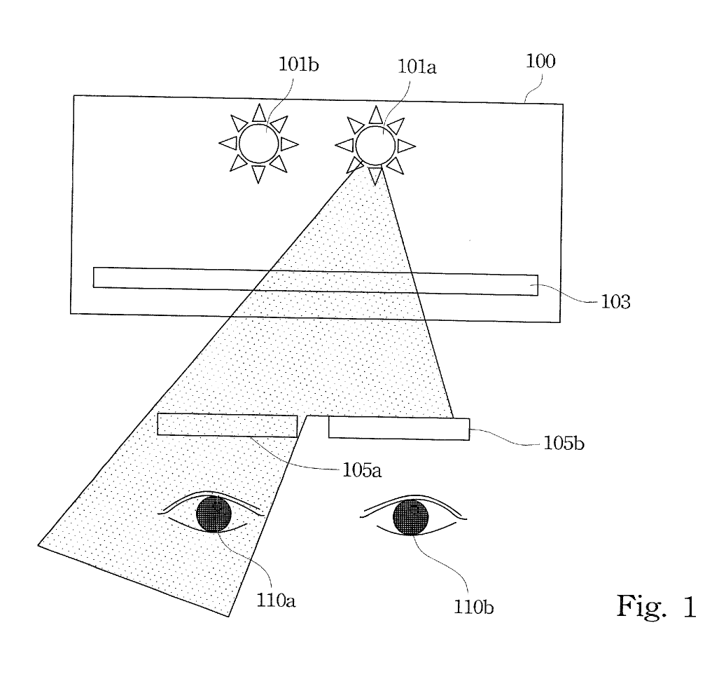

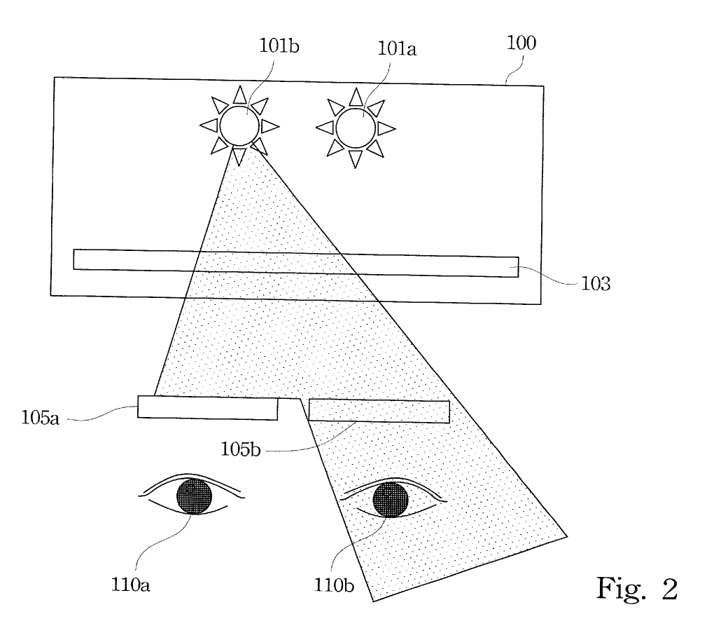

Referring to FIGS. 1&2, which illustrate an operation way of a stereoscopic display device according to a first embodiment of this invention. A stereoscopic display device 100 includes two sets of backlights (101a, 101b), a display panel 103 and other essential optical components or control components. Two sets of backlights (101a, 101b) are two different types of polarized backlights, which illuminate the display panel 103 alternately, thereby producing left-eye visible images and right-eye visible images. The display panel 103 is a non-active illuminative display panel, e.g. a LCD display panel. That is, the display panel 103 needs the illumination from the backlights to output its visible images.

When the backlight 101a emits light (referring to FIG. 1), the backlight 101b does not emit light. Because the polarizing glasses 105a is optically polarized to permit the images carried by the backlight 110a to be visible by the left eye 110a. In contrast, the polarizing glasses 105b is optically polarized to prevent the images carried by the backlight 110a from being visible by the right eye 110b.

When the backlight 101b emits light (referring to FIG. 2), the backlight 101a does not emit light. Because the polarizing glasses 105b is optically polarized to permit the images carried by the backlight 110b to be visible by the right eye 110b. In contrast, the polarizing glasses 105a is optically polarized to prevent the images carried by the backlight 110b from being visible by the left eye 110a.

In an embodiment, two sets of backlights (101a, 101b) can be two types of linearly-polarized backlights, e.g. the backlight 101a is a vertically-polarized backlight while the backlight 101b is a horizontally-polarized backlight. Or, two sets of backlights (101a, 101b) can be two types of linearly-polarized backlights, which are equipped with two mutually orthogonal polarizations.

In an alternate embodiment, two sets of backlights (101a, 101b) can be two types of circularly-polarized backlights, e.g. the backlight 101a is a clockwise-polarized backlight while the backlight 101b is a counter-clockwise-polarized backlight.

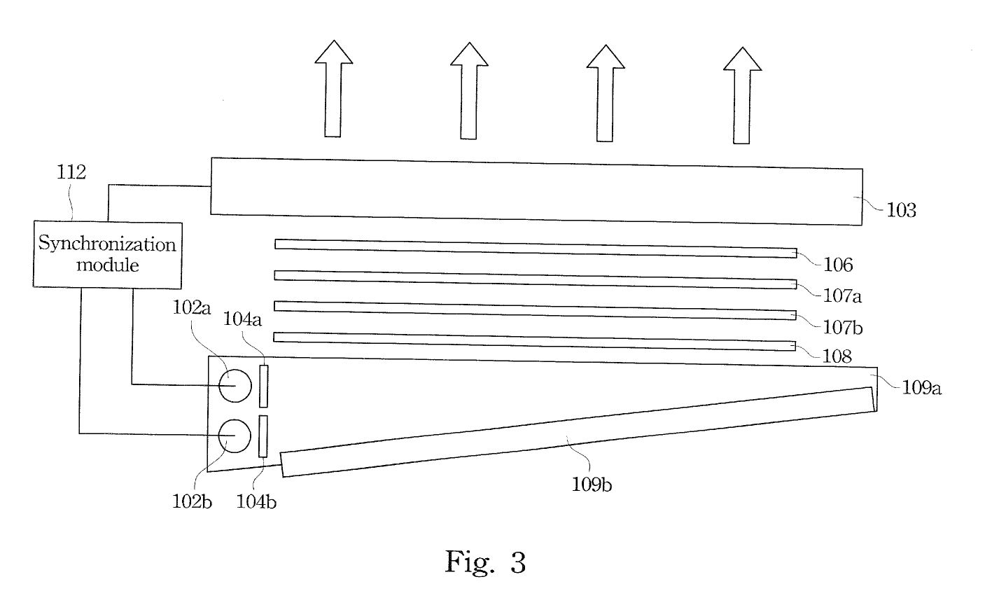

Referring to FIG. 3, which illustrates a detailed structure of the stereoscopic display device according to the first embodiment of this invention. The stereoscopic display device includes a display panel 103, a synchronization module 112 and a backlight module and other optical components. The backlight module includes two light sources (102a, 102b), two polarizing lenses or filters (104a, 104b), a light guide plate 109a and a reflective sheet 109b. The polarizing lenses (104a, 104b) are two different types of polarized polarizing lenses, which is placed in front of the light sources (102a, 102b), thereby generating two different types of polarized backlights.

In an embodiment, the two polarizing lenses (104a, 104b) can be two different types of linearly-polarized polarizing lenses. e.g. the polarizing lens 104a is a vertically-polarized polarizing lens while the polarizing lens 104b is a horizontally-polarized polarizing lens.

In an alternate embodiment, the two polarizing lenses (104a, 104b) can be two different types of circularly-polarized polarizing lenses, e.g. the polarizing lens 104a is a clockwise-polarized polarizing lens while the polarizing lens 104b is a counter-clockwise-polarized polarizing lens.

In this embodiment, the light sources (102a, 102a) can be cold-cathode fluorescent lamps or LED light bars, etc. As illustrated in FIG. 3, the light sources (102a, 102a) and polarizing lenses (104a, 104b) are located at an edge of the light guide plate 109a. In an alternate embodiment, the light sources (102a, 102a) and polarizing lenses (104a, 104b) can be located at two opposite edges of the light guide plate 109a or behind the light guide plate 109a (not illustrated in the drawings). The reflective sheet 109b is to direct light beams towards the display panel 103.

A synchronization module 112 is electrically connected with the display panel 103 and light sources (102a, 102b) for controlling the switching time of the light sources (102a, 102b) such that the two light sources (102a, 102b) can be respectively synchronized with the left-eye visible images and right-eye visible images, which are generated by the display panel 103, such that the viewer's left and right eyes can see the correct sequence of images.

In this embodiment, two prism sheets and two diffuser sheets are located between the display panel 103 and the backlight module. The two diffuser sheets (106, 108) are used to distribute the light uniformly and the two prism sheets (107a, 107b) are used to adjust the directions of the light beams. The choice of optical sheets between the display panel 103 and backlight module is not limited to the components illustrated in FIG. 3. A display designer can choose and arrange optical sheets according to actual demands.

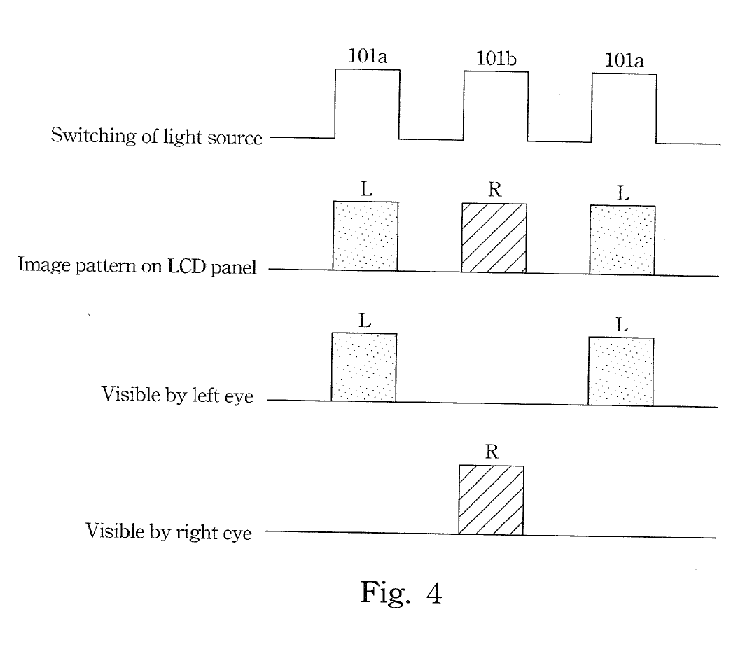

Referring to FIG. 4, which illustrates an operation principle of the stereoscopic display device according to the first embodiment of this invention. This drawing is to describe the major function of the synchronization module 112. The backlight module has two polarized light sources (101a, 101b), which alternately illuminates the display panel. The display panel 103 alternately generates left-eye visible images (L) and right-eye visible images (R) with full resolutions. The major function of the synchronization module 112 is to synchronize the illumination time of the light source 101a with the left-eye visible image (L) and synchronize the illumination time of the light source 101b with the right-eye visible image (R). Therefore, when the viewer wears the polarizer glasses, his or her right eye can see the right-eye visible image (R) while his or her left eye can see the left-eye visible image (L) so as to form a stereoscopic image.

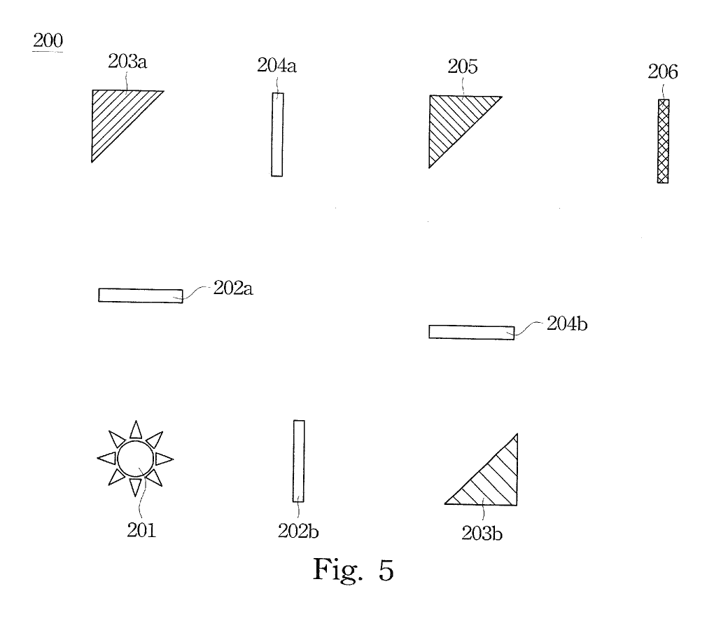

Referring to FIG. 5, which illustrates a detailed structure of a stereoscopic display device according to a second embodiment of this invention. This embodiment is different from the embodiment of FIGS. 1-4 in the backlight design. In this embodiment, the backlight includes a single light source 201, a single transflective prism 205 and two polarizing lens sets so as to generate two different types of polarized backlights. In particular, each polarizing lens set defines an independent polarized backlight for a display panel 206. Each polarizing lens set includes a reflector (203a or 203b), a switch shutter (202a or 202b) and a polarizing lens (204a or 204b). Each switch shutter (202a or 202b) is located between the reflector (203a or 203b) and the single light source 201. Each polarizing lens (204a or 204b) is located between the single transflective prism 205 and the reflector (203a or 203b).

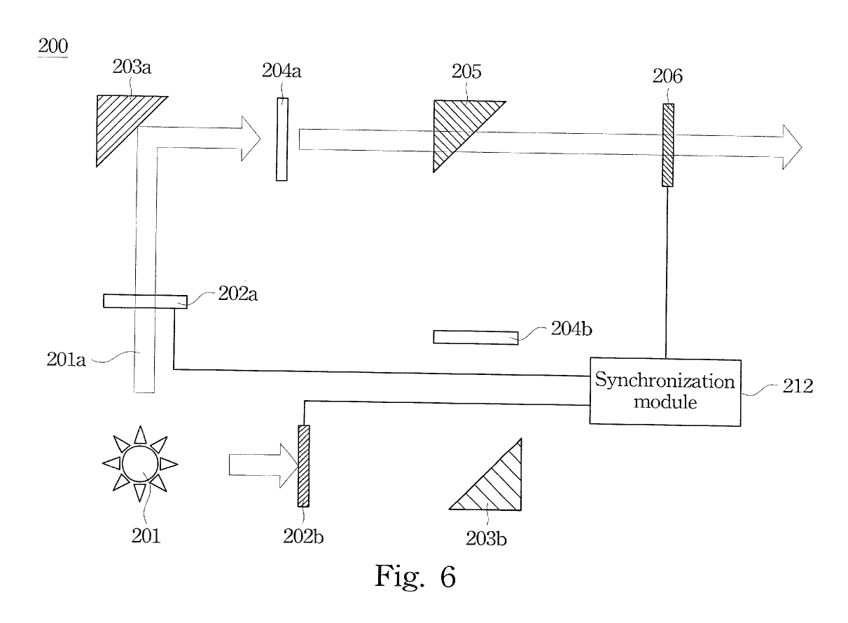

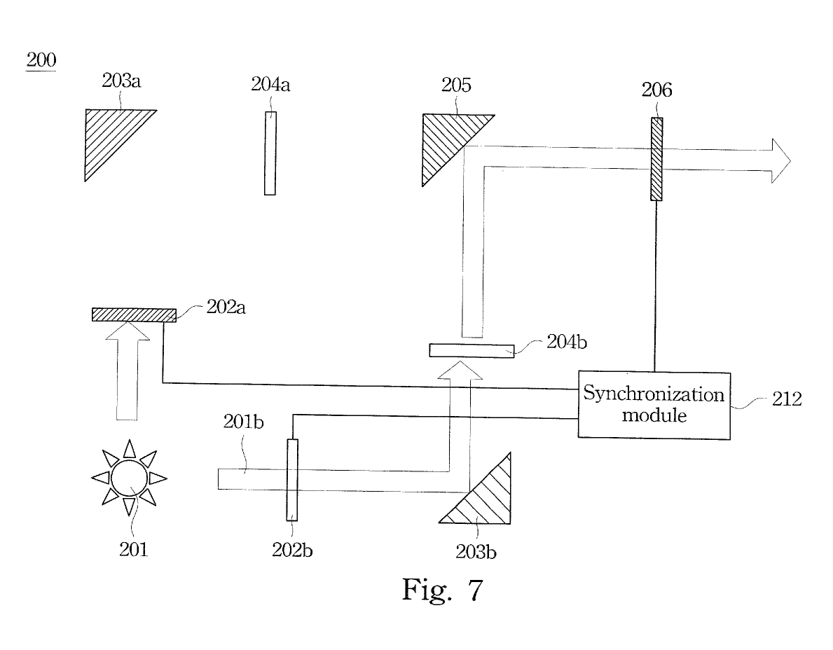

Referring to FIGS. 6&7, which illustrate an operation way of the stereoscopic display device according to the second embodiment of this invention. In FIG. 6, the switch shutter 202a permits the light beams of the light source 201 to pass through while the switch shutter 202b stops the light beams of the light source 201. Therefore, the backlight route 201a goes through the switch shutter 202a, reflected by the reflector 203a, filtered by the polarizing lens 204a, and then goes through the transflective prism 205 and the display panel 206.

In FIG. 7, the switch shutter 202b permits the light beams of the light source 201 to pass through while the switch shutter 202a stops the light beams of the light source 201. Therefore, the backlight route 201b goes through the switch shutter 202b, reflected by the reflector 203b, filtered by the polarizing lens 204b, reflected by transflective prism 205 and then goes through display panel 206.

Because the polarizing lenses (204a, 204b) are two different types of polarized polarizing lenses, thereby generating two different types of polarized backlights for the display panel 206.

In an embodiment, the two polarizing lenses (204a, 204b) can be two different types of linearly-polarized polarizing lenses. e.g. the polarizing lens 204a is a vertically-polarized polarizing lens while the polarizing lens 204b is a horizontally-polarized polarizing lens.

In an alternate embodiment, the two polarizing lenses (204a, 204b) can be two different types of circularly-polarized polarizing lenses, e.g. the polarizing lens 204a is a clockwise-polarized polarizing lens while the polarizing lens 204b is a counter-clockwise-polarized polarizing lens.

A synchronization module 212 is electrically connected with the display panel 206 and two switch shutters (202a, 202b) for controlling the switching time of the single light source 201 such that the two different types of polarized backlights can be respectively synchronized with the left-eye visible images and right-eye visible images, which are generated by the display panel 206, such that the viewer's left and right eyes can see the correct sequence of images.

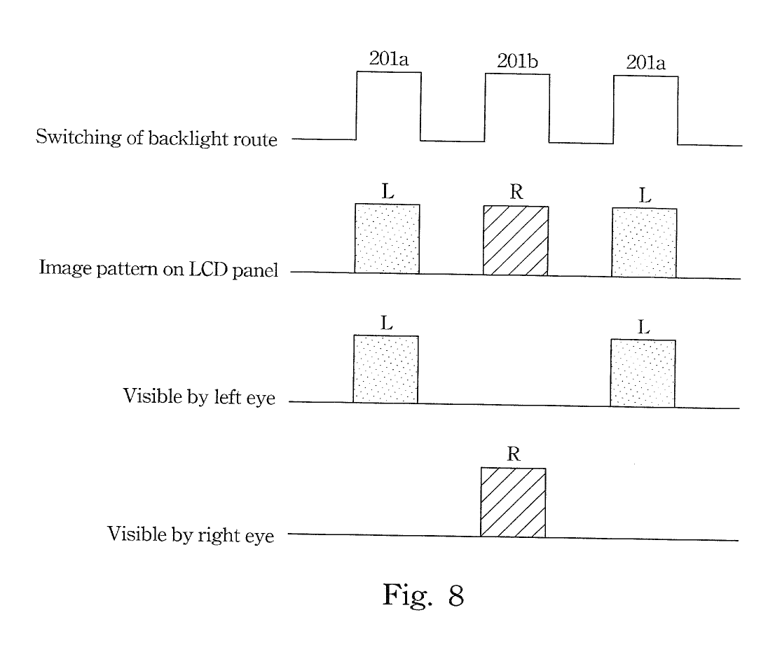

Referring to FIG. 8, which illustrates an operation principle of the stereoscopic display device according to the second embodiment of this invention. This drawing is to describe the major function of the synchronization module 212. The light source 201 provides two different types of polarized backlights via two backlight routes (201a, 201b), which alternately illuminates the display panel 206. The display panel 206 alternately generates left-eye visible images (L) and right-eye visible images (R) with full resolutions. The major function of the synchronization module 212 is to synchronize the switch cycle of the switch shutter 202a with the left-eye visible image (L) and synchronize the switch cycle of the switch shutter 202b with the right-eye visible image (R). Therefore, when the viewer wears the polarizer glasses, his or her right eye can see the right-eye visible image (R) while his or her left eye can see the left-eye visible image (L) so as to form a stereoscopic image.

According to the above-discussed embodiments, the stereoscopic display device disclosed herein utilizes two different types of polarized backlights to alternately illuminates the display panel for alternately generates left-eye visible images and right-eye visible images, thereby combining to form stereoscopic visible images. Besides, the display panel generates left-eye visible images and right-eye visible images with full resolutions, rather than conventional left-eye visible images and right-eye visible images with half resolutions, thereby not sacrificing the resolution of the image.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A stereoscopic display device comprising:
a display panel for alternately generating left-eye visible images and right-eye visible images;
two different polarized backlights for alternately illuminating the display panel so as to output the left-eye visible images and right-eye visible images, respectively; and
a synchronization module for synchronizing the left-eye visible images and right-eye visible images with illumination periods of the respective polarized backlights.

2. The stereoscopic display device of claim 1, wherein the two different polarized backlights comprise two types of linearly-polarized backlights.

3. The stereoscopic display device of claim 2, wherein the two types of linearly-polarized backlights comprise a vertically-polarized backlight and a horizontally-polarized backlight.

4. The stereoscopic display device of claim 1, wherein the two different polarized backlights comprise two types of circularly-polarized backlights.

5. The stereoscopic display device of claim 4, wherein the two types of circularly-polarized backlights comprise a clockwise-polarized backlight and a counter-clockwise-polarized backlight.

6. The stereoscopic display device of claim 1, wherein the two different polarized backlights comprise two cold-cathode fluorescent lamps.

7. The stereoscopic display device of claim 1, wherein the two different polarized backlights comprise two LED light bars.

8. The stereoscopic display device of claim 1, wherein the display panel is a LCD display panel.

9. The stereoscopic display device of claim 1, wherein the display panel is a non-active illuminative display panel.

10. The stereoscopic display device of claim 1, wherein the two different polarized backlights consist essentially of a single light source, a single transflective prism and two polarizing lens sets, each polarizing lens set comprises:
a reflector;
a switch shutter disposed between the reflector and the single light source; and
a polarizing lens disposed between the single transflective prism and the reflector.

11. The stereoscopic display device of claim 10, wherein the two polarizing lens sets comprise two different types of linearly-polarized polarizing lenses.

12. The stereoscopic display device of claim 11, wherein one of the two different types of linearly-polarized polarizing lenses is a vertically-polarized polarizing lens, and the other of the two different types of linearly-polarized polarizing lenses is a horizontally-polarized polarizing lens.

13. The stereoscopic display device of claim 10, wherein the two polarizing lens sets comprise two different types of circularly-polarized polarizing lenses.

14. The stereoscopic display device of claim 13, wherein one of the two different types of circularly-polarized polarizing lenses is a clockwise-polarized polarizing lens, and the other of the two different types of circularly-polarized polarizing lenses is a counter-clockwise-polarized polarizing lens.

15. The stereoscopic display device of claim 10, wherein the synchronization module is electrically connected with the display panel and each switch shutter of the two polarizing lens sets.

16. The stereoscopic display device of claim 10, wherein the two polarizing lens sets define two different types of linearly-polarized backlight routes respectively.

17. The stereoscopic display device of claim 16, wherein one of the two different types of linearly-polarized backlight routes is a vertically-polarized backlight route, and the other of the two different types of linearly-polarized backlight routes is a horizontally-polarized backlight route.

18. The stereoscopic display device of claim 10, wherein the two polarizing lens sets define two different types of circularly-polarized backlight routes respectively.

19. The stereoscopic display device of claim 18, wherein one of the two different types of circularly-polarized backlight routes is a clockwise-polarized backlight route, and the other of the two different types of linearly-polarized backlight routes is a counter-clockwise-polarized backlight route.

20. A stereoscopic image displaying method comprising:
using a display panel to alternately generate left-eye visible images and right-eye visible images;
using two different polarized backlights to alternately illuminate the display panel so as to output the left-eye visible images and right-eye visible images, respectively; and
synchronizing the left-eye visible images and right-eye visible images with illumination periods of the respective polarized backlights.
